(19) United States
(12) Patent Application Publication
(10) Pub. No.: US 2008/0159414 A1
(43) Pub. Date: Jul. 3, 2008

(54) APPARATUS FOR AND METHOD OF BASELINE WANDER MITIGATION IN COMMUNICATION NETWORKS

(75) Inventors: Liran Brecher, Kfar Saba (IL); Itay Lusky, Hod Hasharon (IL); Ariel Yagil, Ramat Hasharon (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/617,590

(22) Filed: Dec. 28, 2006

(51) Int. Cl. H04B 3/04

(52) U.S. Cl. 375/258

(57) ABSTRACT

A novel and useful mechanism for the mitigation of baseline wander from wired networks such as Ethernet. A high pass filter is inserted before the analog to digital converter having a pole within the range of 5-12 MHz. This eliminates the need for any other baseline wander removal schemes, whether analog or digital and provides sufficient performance in terms of noise budget.

### FIELD OF THE INVENTION

The present invention relates to the field of data communications and more particularly relates to an apparatus for and method of mitigation of baseline wander in communication networks.

### BACKGROUND OF THE INVENTION

Modern network communication systems are generally of either the wired or wireless type. Wireless networks enable communications between two or more nodes using any number of different techniques. Wireless networks rely on different technologies to transport information from one place to another. Several examples, include, for example, networks based on radio frequency (RF), infrared, optical, etc. Wired networks may be constructed using any of several existing technologies, including metallic twisted pair, coaxial, optical fiber, etc.

Communications in a wired network typically occurs between two communication transceivers over a length of cable making up the communications channel. Each communications transceiver comprises a transmitter and receiver components. The receiver component typically comprises one or more cancellers. Several examples of the type of cancellers typically implemented in Ethernet transceivers, especially gigabit Ethernet transceivers include, echo cancellers, near-end crosstalk (NEXT) cancellers, far-end crosstalk cancellers (FEXT), etc.

A typical wired communications links is shown FIG. 1. The link, generally referenced 10, comprises 1000Base-T (1000BT) transceivers 12, 16 connected by twisted pair channel 14. The transmitter on each end of the connection takes its respective input data and converts and encodes it for transmission over the twisted pair wiring of the channel. Each receiver is optimized to receive the transmitted signal and decode it to generate the received output data.

Ethernet transceivers on either end of a link are AC coupled to the twisted pair wiring connecting them to each other. Most communication networks (including Ethernet networks) whose links are AC coupled suffer from what is referred to as baseline wander or DC droop. For example, wired Ethernet links such as 10, 100 or 1000 Mbps links all exhibit baseline wander. Baseline wander occurs when a very long pulse propagates through an isolation transformer. Decoupling transformers are a standard component in Ethernet receiver circuits. Decoupling transformers act as a high-pass filter having very low cutoff frequencies which typically prevents most frequencies less than 4 kHz from passing through to the receiver circuit. The decoupling transformer, acting as a high pass filter with an extremely low cutoff frequency, eliminates the DC component of the incoming waveform and causes a long pulse to drift towards the common mode. This is known in the art as “DC droop.”

As a result, transmitted pulses are distorted by a droop effect similar to the exaggerated example shown in FIG. 2. In long strings of identical symbols, the droop can become so severe that the voltage level passes through the decision threshold, resulting in erroneous sampled values for the affected pulses.

When the secondary winding of the decoupling transformer decouples the received waveform and sends the signal to the transceiver chip, the DC component of the original waveform does not pass through. When a coded signal (e.g., MLT-3 coded signal) remains constant (i.e. there are no transitions) for periods longer than the cut-off frequency of decoupling transformer, the output of decoupling transformer begins to decay to common mode as shown in FIG. 2. This phenomenon is caused by the inductive exponential decay of the decoupling transformer.

Depending on the particular code used, certain strings of bits will generate more baseline wander than others. For example, since the MLT-3 code has a transition for every 1 bit and no transition for every 0 bit, only constant 0 bits (not constant 1 bits) converted into MLT-3 code produce a baseline wander condition. Multiple baseline wander events result in an accumulation of offset which manifests itself either more at +1 V or more at −1 V, depending on the direction the wander goes over time. While certain data patterns can cause very severe baseline wander, statistically random data can reduce the amount of baseline wander, but it would still be significant.

The effects of baseline wander can be reduced, however, by encoding the outgoing signal before transmission. This also reduces the possibility of transmission errors. The early Ethernet implementations, including 10Base-T, used the Manchester encoding method wherein each pulse is identified by the direction of the midpulse transition rather than by its sampled level value.

A problem with Manchester encoding, however, it that it introduces frequency related problems that make it unsuitable for use at higher data rates. Ethernet versions subsequent to 10Base-T all use different encoding procedures that make use of one or more of the techniques of data scrambling, expanded code space and forward error correcting codes.

Data scrambling is a technique that scrambles the bits in each byte in an orderly and recoverable way. Some 0s are changed to 1s, some 1s are changed to 0s, and some bits are left the unchanged. The result is reduced run-lengths of same-value bits, increased transition density and easier clock recovery. Expanding the code space is a technique that allows the assignment of separate codes for data and control symbols (e.g., start-of-stream and end-of-stream delimiters, extension bits, etc.) which assists in the detection of transmission errors.

Evan after coding and scrambling, baseline wander can still occur depending on the case and input data. For example, in 100Base-TX baseline wander can still occur because numerous runs of 0 bits can be generated by the scrambler. The scrambler generates numerous 0 bits when certain packets, known as “killer packets,” enter the scrambler. The probability of a killer packet entering a scrambler is a small number out of all the possible data packet permutations. Further, even if a killer packet enters the scrambler, a problem arises only if the data pattern aligns with the scrambler seed. The probability of this happening is one out of every 2,047 tries. Although the occurrence of killer packets are a rare occurrence in the real world statistically, they are often used in during the design and testing of transceivers to demonstrate the baseline wander problem.

Forward error correcting codes are encodings which add redundant information to the transmitted data stream so that some types of transmission errors can be corrected during frame reception. Forward error-correcting codes are used in 1000Base-T to achieve an effective reduction in the bit error rate. Ethernet protocol limits error handling to detection of bit errors in the received frame. Recovery of frames received with uncorrectable errors or missing frames is the responsibility of higher layers in the protocol stack.

Therefore, what is needed is an apparatus and method that is effective in mitigating the effects associated with baseline wander. Ideally, the mechanism would have minimal cost impact in terms of components, power consumption, computing resources and board or chip real estate.

### SUMMARY OF THE INVENTION

The present invention is a novel and useful apparatus for and method of mitigation of baseline wander in communication networks. The mechanism of the present invention is applicable to many types of wired networks and is particularly applicable to 802.3 standard based wired Ethernet networks, including for 10Base-T, 100Base-TX and 1000Base-T networks.

Although the mechanism of the present invention can be used in numerous types of communication networks, to aid in illustrating the principles of the present invention, the baseline wander mitigation mechanism is described in the context of a 1000Base-T Ethernet transceiver (i.e. Gigabit Ethernet or GE). It is appreciated that the invention is not limited to the example applications presented but can be applied to other communication systems as well without departing from the scope of the invention.

The mechanism of the present invention overcomes the problems associated with the prior art by using a conventional high pass filter before the analog to digital converter in the Ethernet transceiver. The high pass filter may also be placed after the analog to digital converter but in this case, it must be implemented digitally. In either case, the high pass filter has a relatively high cutoff frequency (i.e. 3 dB point) of 5 to 12 MHz when compared to the effective high pass filter of the front end magnetics which have a cutoff frequency of anywhere between 50 to 150 kHz.

The use of the high pass filter has several advantages. One advantage is that it is relatively simple to implement, has minimal cost overhead in terms of extra components, power consumption and board space. A second advantage is that it eliminates the need for expanding the dynamic range of the analog to digital converter which would be necessary due to the higher peaks generated at the input to the analog to digital converter. A third advantage is that use of the high pass filter eliminates the need for both analog and digital compensation circuits and techniques typically used in prior art solutions which are costly to implement.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is thus provided in accordance with the present invention, a method of mitigating baseline wander in a communication receiver coupled to a channel, the receiver incorporating a transformer circuit and front end analog to digital converter, the method comprising the steps of applying a signal received over the channel to the transformer circuit to generate an intermediate signal therefrom and high pass filtering the intermediate signal before conversion by the analog to digital converter.

There is also provided in accordance with the present invention, a method of mitigating baseline wander in a communication receiver coupled to a channel, the receiver incorporating a transformer circuit and front end analog to digital converter, the method comprising the steps of applying a signal received over the channel to the transformer circuit to generate an intermediate signal therefrom and high pass filtering the intermediate signal after conversion by the analog to digital converter.

There is further provided in accordance with the present invention, an apparatus for mitigating baseline wander for use in a communications receiver coupled to a communications network, the communications receiver incorporating a front end transformer circuit and analog to digital converter comprising a high pass filter operative to high pass filter a signal output of the front end transformer before conversion of the signal to digital by the analog to digital converter.

There is also provided in accordance with the present invention, a receiver circuit for mitigating baseline wander for use in a communications receiver coupled to a communications channel comprising a front end transformer circuit coupled to the channel and operative to generate an output signal therefrom, a high pass filter operative to high pass filter the output signal to generate a filtered output signal therefrom and an analog to digital converter coupled to the high pass filter and operative to convert the filtered signal to the digital domain.

There is further provided in accordance with the present invention, a communications transceiver coupled to a channel comprising a transmitter coupled to the communications channel, a receiver coupled to the communications channel, the receiver comprising a front end transformer, baseline wander mitigation means and an analog to digital converter and the baseline wander mitigation means comprising a high pass filter operative to high pass filter a signal output of the transformer before conversion to the digital domain by the analog to digital converter.

### BRIEF DESCRIPTION OF THE DRAWINGS

The invention is herein described, by way of example only, with reference to the accompanying drawings, wherein:

FIG. 1 is a block diagram illustrating a typical prior art 1000Base-T network connection;

FIG. 2 is a waveform diagram illustrating the baseline wander problem.

FIG. 3 is a block diagram illustrating an example 1000BT transmitter circuit;

FIG. 4 is a block diagram illustrating an example 1000BT receiver circuit that does not incorporate the high pass filter circuit of the present invention;

FIG. 5 is a block diagram illustrating a first embodiment of an example 1000BT receiver circuit incorporating the high pass filter circuit of the present invention;

FIG. 6 is a block diagram illustrating a second embodiment of an example 1000BT receiver circuit incorporating the high pass filter circuit of the present invention;

FIG. 7 is a graph illustrating the equivalent channel response of the transmitter, receiver and cable with and without the benefit of the present invention;

FIG. 8 is a graph illustrating the intersymbol interference (ISI) performance as a function of the DFE length with and without the benefit of the present invention; and

FIG. 9 is a graph illustrating the peak to average ratio (PAR) at the input of the analog to digital converter versus cable length both with and without the benefit of the present invention.

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| ASIC | Application Specific Integrated Circuit |
| DC | Direct Current |
| DFE | Decision Feedback Equalizer |
| DSL | Digital Subscriber Line |
| DSP | Digital Signal Processor |
| FEXT | Far-End Crosstalk |
| FFE | Feed Forward Equalizer |
| FPGA | Field Programmable Gate Array |
| GE | Gigabit Ethernet |
| HDL | Hardware Description Language |
| IC | Integrated Circuit |
| IEEE | Institute of Electrical and Electronics Engineers |
| ISI | Intersymbol Interference |
| LPF | Low Pass Filter |
| NEXT | Near-End Crosstalk |
| PAR | Peak to Average Ratio |
| RF | Radio Frequency |
| STP | Shielded Twisted Pair |
| UTP | Unshielded Twisted Pair |

### DETAILED DESCRIPTION OF THE INVENTION

The present invention provides a novel and useful apparatus for and method of mitigation of baseline wander in communication networks. The mechanism of the present invention is applicable to many types of wired networks and is particularly applicable to 802.3 standard based wired Ethernet networks, including for 10Base-T, 100Base-TX and 1000Base-T networks.

The mechanism of the present invention overcomes the problems associated with the prior art by using a conventional high pass filter before the analog to digital converter in the Ethernet transceiver. The high pass filter may also be placed after the analog to digital converter but in this case, it must be implemented digitally. In either case, the high pass filter has a relatively high cutoff frequency (i.e. 3 dB point) of 5 to 12 MHz when compared to the effective high pass filter of the front end magnetics which have a cutoff frequency of anywhere between 50 to 150 kHz.

Although the mechanism of the present invention can be used in numerous types of communication networks, to aid in illustrating the principles of the present invention, the description of the baseline wander mitigation mechanism is provided in the context of a 1000Base-T Ethernet transceiver (i.e. Gigabit Ethernet or GE). The baseline wander mitigation mechanism of the present invention has been incorporated in an Ethernet IC adapted to provide 10Base-T, 100Base-TX and 1000Base-T communications over a metallic twisted pair channel. Although the invention is described in the context of a gigabit Ethernet PHY communications link, it is appreciated that the invention is not limited to the example applications presented, but that one skilled in the art can apply the principles of the invention to other communication systems as well without departing from the scope of the invention.

It is appreciated by one skilled in the art that the baseline wander mitigation mechanism of the present invention can be adapted for use with numerous other types of wired communications networks such as asynchronous or synchronous DSL channels, coaxial channels, etc. without departing from the scope of the invention.

Note that throughout this document, the term communications device is defined as any apparatus or mechanism adapted to transmit, receive or transmit and receive data through a medium. The term communications transceiver is defined as any apparatus or mechanism adapted to transmit and receive data through a medium. The communications device or communications transceiver may be adapted to communicate over any suitable medium, including wired media such as twisted pair cable or coaxial cable. The term Ethernet network is defined as a network compatible with any of the IEEE 802.3 Ethernet standards, including but not limited to 10Base-T, 100Base-T or 1000Base-T over shielded or unshielded twisted pair wiring. The terms communications channel, link and cable are used interchangeably.

The term baseline wander is defined as a phenomenon that occurs when a waveform is passed through a decoupling transformer, also referred to as “DC droop,” which results in a large drift of the waveform above or below the return voltage, often measured in hundreds of millivolts. A waveform is defined as a train of pulses.

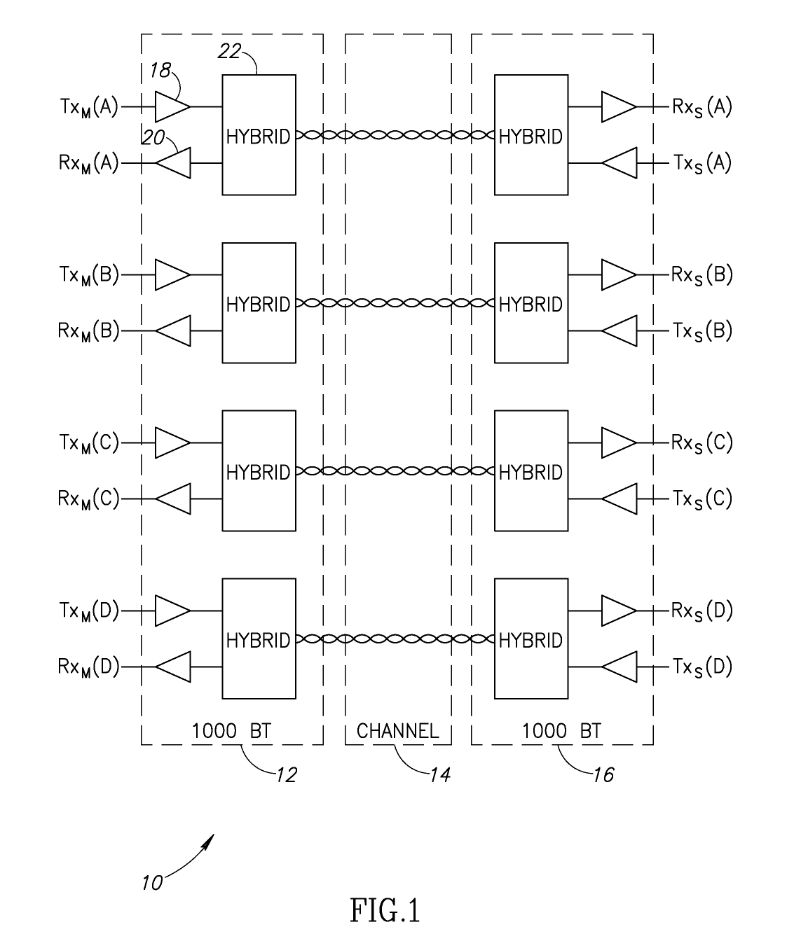

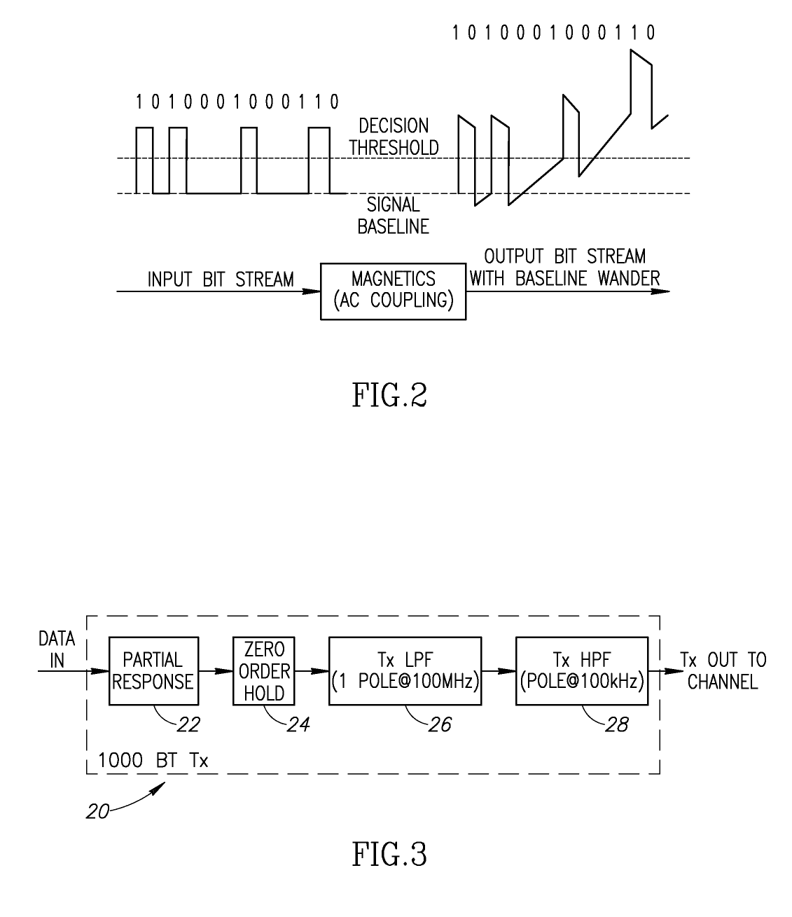

A block diagram illustrating the typical 1000Base-T connection or link is shown in FIG. 1. The link, generally referenced 10, comprises two transceivers 12 and 16, each comprising a plurality of transmitters 18, receivers 20 and hybrid circuits 22. The transceivers are coupled by a plurality of twisted pair cables 14. A gigabit Ethernet communications link is characterized by full duplex transmission over Category 5 and higher cable that may be shielded (STP) or unshielded twisted pair (UTP) cable. The cable comprises four twisted metallic copper pairs wherein all four pairs are used for both transmission and reception. Note that for notation purposes, each one of the twisted pairs is referred to as a ‘channel’ and the combined four twisted pair bundle generating one gigabit Ethernet connection is referred to as a ‘cable’.

In operation, each transceiver receives an input data stream from an external data source such as a host or other entity (not shown). The transceiver generates an output symbol stream from the input data stream and transmits the output symbol stream over the communications channel to the transceiver on the other side. The transceivers on either end of a channel are considered link partners. A link partner can be either active or inactive. An inactive link partner is a transceiver that is not transmitting at the moment. An active link partner is a transceiver that is currently transmitting.

In the receive direction, each transceiver receives a receive signal from the communications channel. The receive signal may comprise an input symbol stream transmitted from the link partner. The transceiver generates an output from this input symbol stream. The receive signal may also comprise a signal representing energy from any number of interference sources, e.g., an echo signal representing the original transmitted signal that has been reflected back towards the transceiver. The transmitted signal may be reflected back due to a channel fault such as an open cable, shorted cable, unmatched load or any irregularities in impedance along the length of the cable. Such irregularities may be caused by broken, bad or loose connectors, damaged cables or other faults.

The Ethernet PHY environment is typically exposed to diverse interference sources. Several of these interference sources include near-end echo, far-end echo, attenuation, near-end crosstalk and far-end crosstalk. Another impairment, commonly considered an ISI problem is baseline wander which the present invention attempts to mitigate. The main interference sources (i.e. Ethernet impairments or noise sources) an Ethernet transceiver is exposed are described below. Note that these and other impairments may be applicable to other communication link PHY schemes and are not to be limited to gigabit Ethernet.

A simplified block diagram illustrating an example of a conventional 1000BT transmitter circuit is shown in FIG. 3. The transmitter, generally referenced 20, comprises a partial response shaper 22, zero order hold block 24, transmit low pass filter (LPF) 26 and Ethernet transmitter magnetics 28. The transmit low pass filter 26 has one pole at approximately 100 MHz (between 70.8 MHz to 117 MHz in the example system described herein). The magnetics 28 comprise, inter alia, an isolation transformer which can effectively be modeled as a high pass filter having a pole at approximately 100 kHz or lower.

In operation, data symbols to be transmitted on the link are generated from the TX data input to the transmitter. The partial response filter functions as a pulse shaping filter which shapes the symbols for better transmission over the link. The symbols are then low pass filtered and then output through the isolation transformer.

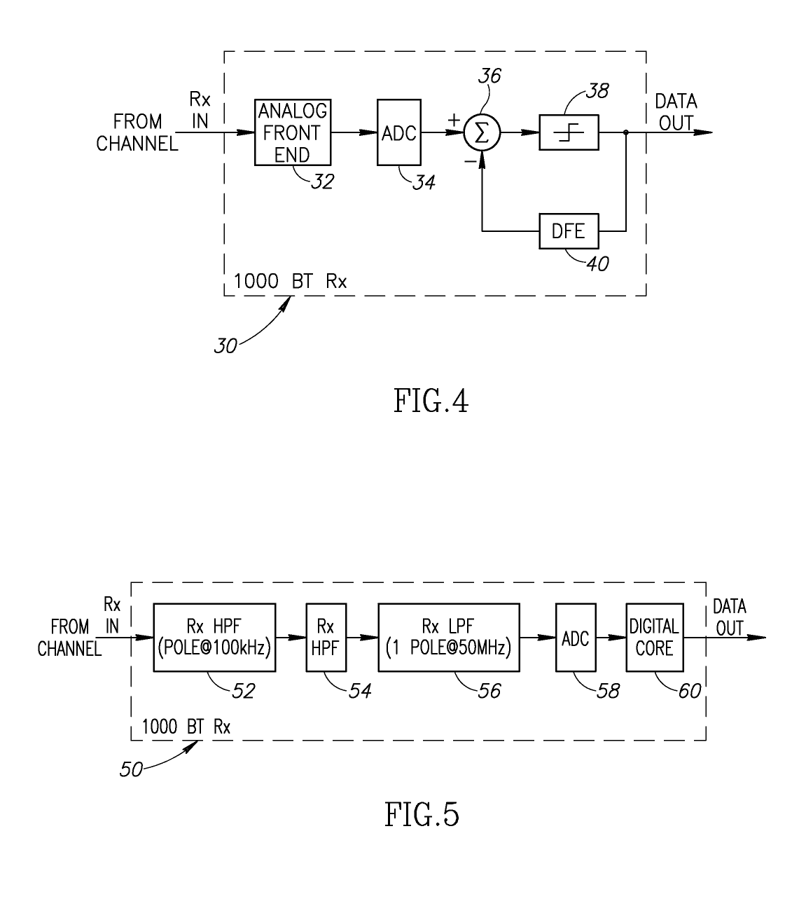

A simplified block diagram illustrating a conventional example 1000BT receiver circuit that does not incorporate the high pass filter circuit of the present invention is shown in FIG. 4. The receiver circuit, generally referenced 30, comprises a analog front end circuit 32, analog to digital converter 34, adder 36, slicer 38 and decision feedback equalizer (DFE) 40. The analog front end circuit 32 normally comprises the magnetics (which includes a receive isolation transformer), hybrid circuit and analog filtering (i.e. low pass).

As a solution to the baseline wander problem, the DFE is used to compensate for the ISI and baseline wander effects. In operation, however, without the high pass filter of the present invention in the receive circuit path, the DFE attempts to compensate for intersymbol interference (ISI) which spans many hundreds of symbols. To deal effectively with hundreds of symbols, however, requires very large memory capacity for the DFE and processing resources which is not practical to provide in most cases.

Therefore, in accordance with the invention, a simpler, less costly technique is provided that is effective as mitigating the baseline wander problem. A simplified block diagram illustrating a first embodiment of an example 1000BT receiver circuit incorporating the high pass filter circuit of the present invention is shown in FIG. 5. The receiver, generally referenced 50, comprises the magnetics 52, an analog front end circuit (including a high pass filter 54 and a low pass filter 56), analog to digital converter 58 and digital core circuit 60. The magnetics 52 comprises an isolation transformer that can be modeled as a high pass filter having a 3 dB cutoff frequency at approximately 100 kHz or lower. The high pass filter 54 is significantly different from that of high pass filter 52 in that the 3 dB cutoff frequency is in the range of 5 to 12 MHz, significantly higher than the 100 kHz of filter 52.

Typically the effects of baseline wander impairment include a significant increase in the total noise budget and an increase in the signal backoff at the input to the analog to digital converter which results in increased analog to digital converter quantization noise. It is noted that both these effects are enhanced in the presence of so called “killer packets” defined for 100Base-TX and 1000Base-T.

As described supra, a conventional receiver attempts to compensate of the baseline wander using equalization (e.g., DFE). The problem is that the equalizer must compensate by applying DFE over hundreds (e.g., 500) of symbols. This requires large amounts of memory which is not practical. The invention treats the baseline wander not as an impairment but rather as ISI. In addition, the invention does not attempt to completely eliminate the ISI that is present in the received signal. Rather, it attempts to modify the receive signal to make it practical for the DFE to eliminate as much of the ISI as possible without the large memory requirement that would be needed without the benefit of the invention. In accordance with the invention, a high pass filter is added before the analog to digital converter having a cutoff frequency substantially higher than that of the inherent high pass filter representing the isolation transformer of the magnetics at the front end of the transceiver.

The high pass filter, which is typically implemented in analog but could be digitally implemented, has a pole at a higher frequency such in the range of 5 to 12 MHz. Other frequencies are possible as well depending on the particular implementation. The use of the high pass filter makes it much easier for the DFE to cope with the channel which for description purposes includes the baseline wander phenomenon (even though it is a receiver phenomenon).

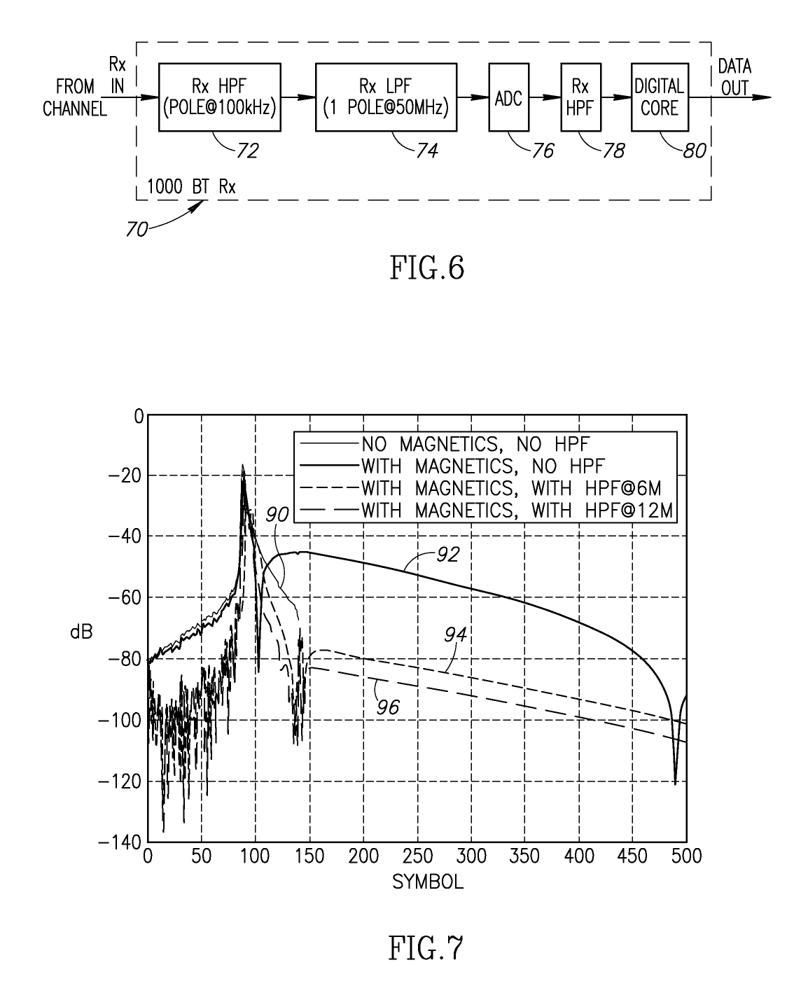

A block diagram illustrating a second embodiment of an example 1000BT receiver circuit incorporating the high pass filter circuit of the present invention is shown in FIG. 6. The receiver circuit, generally referenced 70, comprises the magnetics 72, an analog front end circuit (including low pass filter 74), analog to digital converter 76, receiver high pass filter 78 and digital core circuit 80. The magnetics 74 comprises an isolation transformer that can be modeled as a high pass filter having a 3 dB cutoff frequency at approximately 100 kHz or lower. The high pass filter 78 is significantly different from that of high pass filter 74 in that the 3 dB cutoff frequency is in the range of 5 to 12 MHz, significantly higher than the 100 kHz of filter 74. In this alternative embodiment, the high pass filter is situated after the analog to digital converter, thus it is implemented in the digital domain.

It is important to note that this alternative embodiment is less then ideal for the following reason. The disadvantage of implementing the high pass filter digitally after the analog to digital converter is the increased peak to average ratio at the input to the analog to digital converter. The baseline wander causes higher peaks to build up at the analog to digital converter. The amplitude of the peaks of the analog to digital converter are much higher if the high pass filter is not implemented before the analog to digital converter due to the transfer function response of the circuit. Higher peaks translate to increased dynamic range that is required and this translates to additional bits for the analog to digital converter which is not practical. Thus, placing the high pass filter before the analog to digital converter results in a similar impact on frequency response and at the same time generates normal size peaks at the input to the analog to digital converter ADC.

A graph illustrating the equivalent channel response of the transmitter, receiver and cable with and without the benefit of the present invention is shown in FIG. 7. The graph shown in FIG. 7 presents the energy of the equivalent impulse response of the combined transmitter, receiver and cable over time. In this example, the cable is 120 meters long Cat5 cable (i.e. IEEE specified cable characteristics). The impulse is shown for four different cases. Trace 90 represents the impulse response of a receiver with no magnetics (i.e. no isolation transformer) and no high pass filter. Trace 92 represents the impulse response of a receiver with magnetics but no high pass filter. Trace 94 represents the impulse response of a receiver with magnetics and a receive high pass filter with a pole at 6 MHz. Trace 96 represents the impulse response of a receiver with magnetics and a receive high pass filter with a pole at 12 MHz.

Note that trace 92 represents a significant amount of ISI which is far from the main tap which is difficult to compensate for using DFE. Adding the additional high pass filter (traces 94, 96) having a high cutoff frequency of 6 or 12 MHz significantly reduces the ISI. Note that use of the high pass filter increases the effective length of the resultant channel response with large reflections at a distance of 100 taps and more from the leading tap. The analog high pass filter in the receiver, however, reduces the far reflections by approximately 30 dB and can be considered an analog feedforward equalizer (FFE) for long cables.

Note also that the use of the high pass filter is a tradeoff, as more of the desired signal is filtered as well as the ISI. This has an impact on the noise budget. In this case, some noise along with the signal is permitted but the overall ratio of signal to noise is approximately the same as without the invention. Thus, considering all the noise sources including the channel DFE taps, echo canceller, etc., the invention causes virtually no degradation in performance.

Note further that increases in the cutoff frequency of the high pass filter will at some point sufficiently degrade performance to where the transceiver falls out of specification or in severe cases where communication is not possible. This is because increasing the cutoff frequency causes more of the desired signal to be filtered out. The limit of 5 to 12 MHz suggested herein was derived from simulation and experimentation.

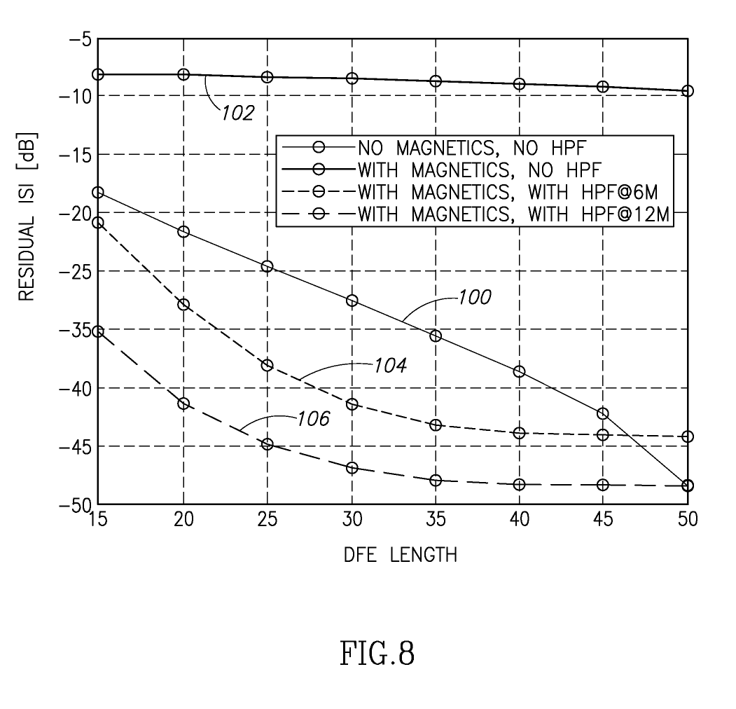

FIG. 8 is a graph illustrating the residual intersymbol interference (ISI) performance in 120M Cat5 cable as a function of the DFE length for the four cases described above in connection with FIG. 7. In particular, the residual ISI is shown for four different cases. Trace 100 represents the residual ISI with no magnetics (i.e. no isolation transformer) and no high pass filter. Trace 102 represents the residual ISI with magnetics but no high pass filter. Trace 104 represents the residual ISI with magnetics and a receive high pass filter with a pole at 6 MHz. Trace 106 represents the residual ISI with magnetics and a receive high pass filter with a pole at 12 MHz.

A significant improvement is obtained by use of the high pass filter over the cases of no magnetics and with magnetics with no high pass filter. At a DFE length of 30 taps, the residual ISI for the case of no magnetics is approximately −27.5 dB while it is −7 dB for the case of magnetics but no high pass filter. The addition of the high pass filter reduces the residual ISI to −37 dB and −42 dB for 6 and 12 MHz cutoff, respectively.

In this example, the effect of the magnetics is compensated for by the analog high pass filter and the DFE (having a practical length of 35 taps). Alternatively, a reduction in ISI can be obtained by using a long enough FFE which will naturally converge to a filter of high pass nature (using an adaptive algorithm such as LMS). The analog high pass filter solution, however, is more optimal in terms of noise budget for the reasons of (1) reduced analog to digital converter backoff; and (2) less noise enhancement (the high pass filter is implemented in the analog domain and hence analog to digital converter quantization noise is not increased).

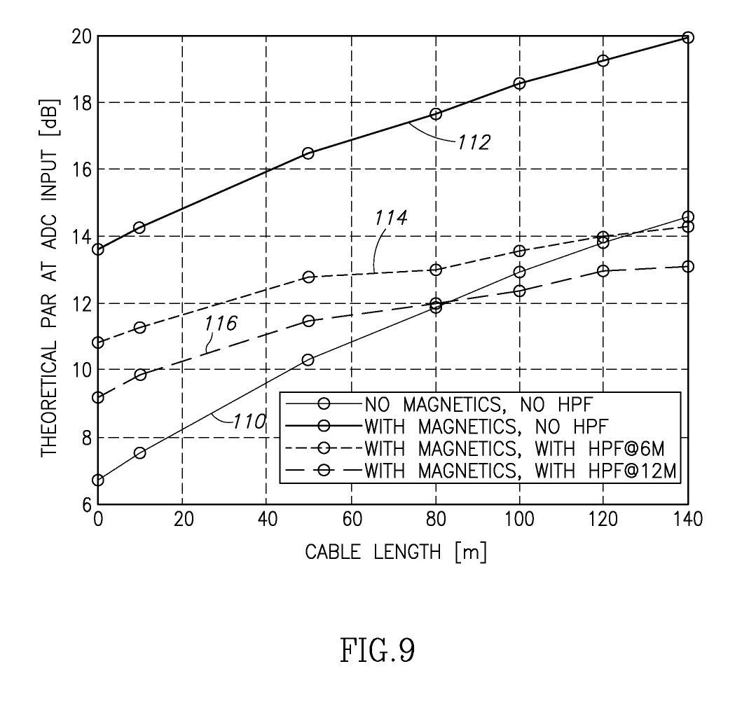

A graph illustrating the peak to average ratio (PAR) at the input of the analog to digital converter versus cable length both with and without the benefit of the present invention is shown in FIG. 9. The peak to average is affected by the overall frequency response from the transmitter to the receiver. The frequency response also depends on the cable length. Note that the theoretical upper bound of the PAR at the input to the ADC is shown assuming a 3PAM constellation. The theoretical PAR can be calculated using the following:

$${PAR}_{@ ADC\_input} = {PAR}_{3 PAM} + 10 {log}_{10} ( \frac{{( {\sum }_{n} \vert {h}_{n} \vert )}^{2}}{{\sum }_{n} {\vert {h}_{n} \vert}^{2}} ) \qquad ( 1 )$$

Where hₙ is the equivalent channel impulse response presented in FIG. 9.

Line 110 represents the PAR without the transformers (i.e. magnetics). Note that the PAR increases as the cable length increases because of changes to the frequency response due to the cable acting as a low pass filter. The slope of the line decreases as the cable length increases. Higher cable length means a steeper channel and higher peak to average signal.

Even at the longest cable length (140 meters), the PAR is approximately 15 dB. Adding the transformer in the magnetics increases the PAR by about 6 dB (trace 112). This translates to approximately an additional bit required for the analog to digital converter which may or may not be available depending on the application. The addition of the high pass filter in traces 114 and 116 results in a PAR very similar to that of the case without the transformers. Thus, the addition of the high pass filter solves two problems simultaneously. The first being the ISI problem and the second being the peak to average problem at the analog to digital converter.

Note that the theoretical PAR is approximately 14 dB at a cable length of 140 meters using the analog HPF having a pole at 6 MHz. The response is event better (i.e. 13 dB) using the analog HPF with a pole at 12 MHz. Thus, there is no need for additional analog baseline wander removal techniques since the receiver circuit is able to handle a 12 dB backoff and have a reasonable saturation rate, even in the presence of killer packets.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of mitigating baseline wander in a communication receiver coupled to a channel, said receiver incorporating a transformer circuit and front end analog to digital converter, said method comprising the steps of:
applying a signal received over said channel to said transformer circuit to generate an intermediate signal therefrom; and
high pass filtering said intermediate signal before conversion by said analog to digital converter.

2. The method according to claim 1, wherein said step of high pass filtering is performed in the analog domain.

3. The method according to claim 1, wherein said step of high pass filtering comprises applying high pass filtering having a 3 dB cutoff frequency of between 5 and 12 MHz.

4. The method according to claim 1, wherein said channel comprises an Ethernet channel.

5. The method according to claim 1, wherein said channel comprises a 1000Base-T Ethernet channel.

6. A method of mitigating baseline wander in a communication receiver coupled to a channel, said receiver incorporating a transformer circuit and front end analog to digital converter, said method comprising the steps of:
applying a signal received over said channel to said transformer circuit to generate an intermediate signal therefrom; and
high pass filtering said intermediate signal after conversion by said analog to digital converter.

7. The method according to claim 6 wherein said step of high pass filtering is performed in the digital domain.

8. The method according to claim 6, wherein said step of high pass filtering comprises applying high pass filtering having a 3 dB cutoff frequency of between 5 and 12 MHz.

9. The method according to claim 6, wherein said channel comprises an Ethernet channel.

10. The method according to claim 6, wherein said channel comprises a 1000Base-T Ethernet channel.

11. An apparatus for mitigating baseline wander for use in a communications receiver coupled to a communications network, said communications receiver incorporating a front end transformer circuit and analog to digital converter, comprising:
a high pass filter operative to high pass filter a signal output of said front end transformer before conversion of said signal to digital by said analog to digital converter.

12. The apparatus according to claim 11, wherein said high pass filter comprises a 3 dB cutoff frequency approximately between 5 and 12 MHz.

13. The apparatus according to claim 11, wherein said network comprises an Ethernet network.

14. The apparatus according to claim 11, wherein said network comprises a 1000Base-T Ethernet network.

15. A receiver circuit for mitigating baseline wander for use in a communications receiver coupled to a communications channel, comprising:
a front end transformer circuit coupled to said channel and operative to generate an output signal therefrom;
a high pass filter operative to high pass filter said output signal to generate a filtered output signal therefrom; and
an analog to digital converter coupled to said high pass filter and operative to convert said filtered signal to the digital domain.

16. The receiver according to claim 15, wherein said high pass filter comprises a 3 dB cutoff frequency approximately between 5 and 12 MHz.

17. The receiver according to claim 15, wherein said channel comprises an Ethernet channel.

18. The receiver according to claim 15, wherein said channel comprises a 1000Base-T Ethernet channel.

19. A communications transceiver coupled to a channel, comprising:
a transmitter coupled to said communications channel;
a receiver coupled to said communications channel, said receiver comprising a front end transformer, baseline wander mitigation means and an analog to digital converter; and
said baseline wander mitigation means comprising a high pass filter operative to high pass filter a signal output of said transformer before conversion to the digital domain by said analog to digital converter.

20. The transceiver according to claim 19, wherein said high pass filter comprises a 3 dB cutoff frequency approximately between 5 and 12 MHz.

21. The transceiver according to claim 19, wherein said channel comprises an Ethernet channel.

22. The transceiver according to claim 19, wherein said channel comprises a 1000Base-T Ethernet channel.
